(19) United States
(12) Patent Application Publication
(10) Pub. No.: US 2008/0037925 A1
(43) Pub. Date: Feb. 14, 2008

(54) DGD compensating apparatus

(75) Inventors: Eisuke Sasaoka, Yokohama-shi (JP); Michiko Takushima, Yokohama-shi (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 11/882,287

(22) Filed: Jul. 31, 2007

(30) Foreign Application Priority Data
Aug. 1, 2006 (JP) P2006-209921

(51) Int. Cl. H04B 10/18

(52) U.S. Cl. 385/11

(57) ABSTRACT

A DGD compensating apparatus capable of compensating the time varying DGD of each wavelength component in the propagation light. The DGD of each wavelength component in the inputted light is monitored by a DGD monitor, and a polarization splitter splits the inputted light into first polarization light and second polarization light orthogonal to each other. The first polarization light is de-multiplexed by de-multiplexer for each wavelength component, and the de-multiplexed wavelength components in the first polarization light are multiplexed by a multiplexer after being respectively added with delays by an optical delay. The first polarization light in which each wavelength component is added with the associated delay and the second polarization light are combined and thereafter being outputted by a polarization combiner.

### BACKGROUND OF THE INVENTION

1. Field of the Invention

The present invention relates to an apparatus for compensating Differential Group Delay (hereinafter referred to as “DGD”) between first and second polarizations which are orthogonal to each other and which occurs while light propagates.

2. Related Background Art

Optical fibers employed in optical transmission systems serve as an optical transmission path along which a wavelength division multiplexing signal light (WDM signal light), having a plurality of wavelength components with wavelengths different from each other, propagates. As the WDM signal light propagates along an optical fiber transmission path, waveform deterioration of each wavelength component occurs due to chromatic dispersion and polarization mode dispersion. Significant waveform deterioration caused in each wavelength component inhibits both high bit-rate transmission and long haul transmission. Accordingly, low chromatic dispersion and polarization mode dispersion in an optical fiber transmission path are desirable.

Polarization mode dispersion is a phenomenon of variable Differential Group Delay between the polarizations in light due either to circular asymmetry of the cross-sectional shape of the core of the optical fiber or a side-pressure being exerted on the optical fiber. The amount of signal light dispersion caused by polarization mode dispersion is manifested as the Differential Group Delay (DGD) between first and second polarizations orthogonal to each other.

Incidentally, while DGD differs in accordance with wavelength, it is also known to vary over time, as can be seen from P. K. Kondamuri et al., “Study of variation of the Laplacian parameter of DGD time derivative with fiber length using measured DGD data”, Symposium on Optical Fiber Measurements 2004, Technical Digest, pp. 91-94 (204).

### SUMMARY OF THE INVENTION

The present inventors have examined the above prior art, and as a result, have discovered the following problems. That is, although apparatuses of compensating DGD has been hitherto proposed, there is no known a practicable one of DGD compensating apparatuses each capable of compensating the time varying DGD of each wavelength component included in WDM light.

The present invention has been developed to eliminate the problems described above. It is an object of the present invention to provide a DGD compensating apparatus able to compensate the time varying DGD for each wavelength component.

A DGD compensating apparatus according to the present invention is an apparatus for compensating the Differential Group Delay (DGD) between first and second polarizations which are orthogonal to each other and are included in the light propagating from an input port to an output port. The DGD compensating apparatus according to the present invention comprises an input port, an output port, a DGD monitor, a polarization splitter, an optical de-multiplexer, an optical delay, an optical multiplexer, and a polarization combiner.

The input port is provided as to input light having a plurality of wavelength components of wavelengths different from each other. The output port is provided so as to output light in which DGD of each wavelength component is compensated outside of the apparatus. The DGD monitor is provided on an optical path between the input port and the output port, and monitors DGD of each wavelength component included in the inputted light through the input port. The polarization splitter is provided on an optical path between the DGD monitor and the output port, and splits the inputted light into first polarization light and second polarization light. The optical de-multiplexer is provided on an optical path between the polarization splitter and the output port, and de-multiplexes the first polarization light split by said polarization splitter for each wavelength component. The optical delay adds a delay according to the DGD of each wavelength component, which is monitored by the DGD monitor, to the associated wavelength components in the first polarization light de-multiplexed by the optical de-multiplexer. The optical multiplexer multiplexes the wavelength components in the first polarization light which are de-multiplexed by the optical de-multiplexer and have been added with the associated delays by the optical delay. The optical delay is provided on an optical path between the optical de-multiplexer and the optical multiplexer. The polarization combiner is optically connected to the polarization splitter through a bypass for transmitting the second polarization light split by the polarization splitter. The polarization combiner combines the first polarization light in which the wavelength components are multiplexed by the multiplexer and the second polarization light which has been split by the polarization splitter.

In the DGD compensating apparatus according to the present invention, the DGD of each wavelength component of the inputted light is monitored by the DGD monitor, and the imputed light is split by the polarization splitter into first polarization light and second polarization light orthogonal to each other. The first polarization light, which is split by and is outputted from the polarization splitter, is de-multiplexed by the optical de-multiplexer for each wavelength component, and then multiplexed by the optical multiplexer after the wavelength components in the first polarization light are respectively added with the delays, each corresponding to the DGD of the associated wavelength component monitored by the DGD monitor, by the optical delay Thereafter, the first polarization light in which the wavelength components are multiplexed by the optical multiplexer and the second polarization light split by the polarization splitter are combined, and are outputted by the polarization combiner.

In the DGD compensating apparatus according to the present invention, it is preferable that the optical delay comprises a variable delay mirror. The variable delay mirror has a plurality of reflection mirrors corresponding to wavelength components, and these reflection mirrors are able to be independently moved in a vertical direction to a reflection plane of each reflection mirror. Also, the optical delay may comprise a transmission-type delay element having a plurality of pixels configured from a liquid crystal material. Furthermore, the optical delay may comprise an optical waveguide having multiple cores.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will be apparent to those skilled in the art from this detailed description.

### BRIEF DESCRIPTION OF THE DRAWINGS

FIG. 1 is a schematic diagram of an embodiment of a DGD compensating apparatus according to the present invention.

### DESCRIPTION OF THE PREFERRED EMBODIMENTS

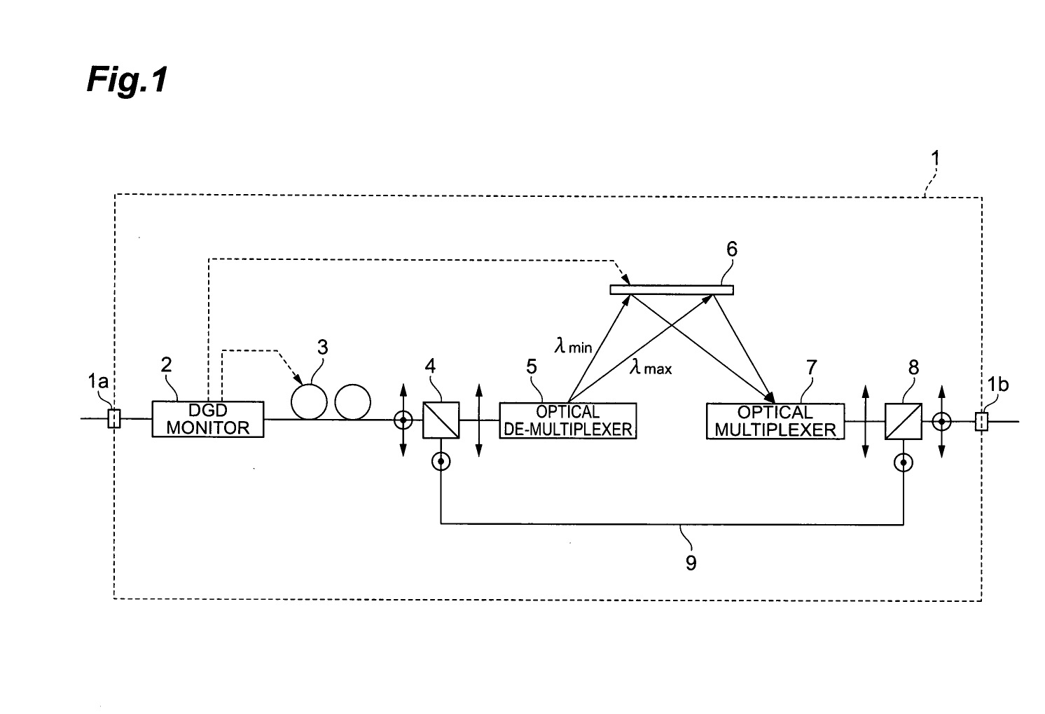

In the following, an embodiment of a DGD compensating apparatus according to the present invention will be explained in detail with reference to FIG. 1. In the description of the drawings, identical or corresponding components are designated by the same reference numerals, and overlapping description is omitted.

FIG. 1 is a schematic diagram of an embodiment of a DGD compensating apparatus according to the present invention. The DGD compensating apparatus 1, as shown in FIG. 1, comprises an input port 1a and an output port 1b, and further comprises a DGD monitor 2, a polarization controller 3, a polarization splitter 4, an optical de-multiplexer 5, an optical delay 6, an optical multiplexer 7, a polarization combiner 8, and a bypass optical fiber 9 which are provided on an optical path between the input port 1a and the output port 1b.

The DGD monitor 2, into which the light having a plurality of wavelength components with wavelengths different from each other is input, monitors the DGD of each wavelength component and also detects the polarization principal axis directions of these wavelength components. The polarization controller 3 rotates each polarization plane of the inputted light in accordance with the associated polarization principal axis direction result detected by the DGD monitor 2, and matches each polarization principal axis direction of the rotated polarization planes with the polarization principal axis direction of the polarization splitter 4.

The polarization splitter 4 polarization-splits the inputted light into first polarization light and second polarization light which are orthogonal to each other. And then the polarization splitter 4 outputs the split first polarization light to the optical de-multiplexer 5 and outputs the split second polarization light into the bypass optical fiber 9. The polarization splitter 4 includes, for example, a polarization beam splitter. The optical de-multiplexer 5 de-multiplexes the split first polarization light for each wavelength component, and spatially expands these de-multiplexed wavelength components in the first polarization light (from minimum wavelength of λmin to maximum wavelength of λmax).

The optical delay 6 adds the delay, according to the DGD of each wavelength obtained by the monitoring of the DGD monitor 2, to each wavelength component in the first polarization light de-multiplexed by the optical de-multiplexer 5. The optical delay 6 preferably includes, for example, a variable delay mirror which has a plurality of reflection mirrors provided corresponding to each wavelength component are able to be independently moved in a vertical direction to the reflection plane of each reflection mirror. In this case, each wavelength component in the first polarization light is added with the delay in accordance with a displacement amount of the associated reflection mirror by moving the associated reflection mirror in the displacement amount in accordance with the DGD of each wavelength component. By this, the DGD can be compensated for each wavelength component. The optical delay 6 configured in this way is ideally able to be realized using MEMS (micro-electro-mechanical system) technology.

The optical multiplexer 7 multiplexes the wavelength components in the first polarization light to which the associated delays have been added by the optical delay 6. The polarization combiner 8, into which both the first polarization light in which the wavelength components are multiplexed by the optical multiplexer 7 and the second polarization light polarization-split by the polarization splitter 4 and arriving by way of the bypass optical fiber 9 are inputted, combines the first polarization light and the second polarization light. The polarization combiner 8 is, for example, a polarization beam splitter.

The DGD compensating apparatus 1 according to the present embodiment acts as follows. The DGD of each wavelength component included in the light inputted into the DGD compensating apparatus 1 is monitored by, and the polarization principal axis direction of the inputted light is detected by the DGD monitor 2. In addition, the polarization plane of the inputted light is rotated in accordance with a polarization principal axis direction result detected by the DGD monitor 2, and the rotated polarization principal axis direction of the inputted light is matched with the polarization principal axis direction of the polarization splitter 4 by the polarization controller 3 before being polarization-split into first polarization light and second polarization light orthogonal to each other by the polarization splitter 4.

The first polarization light outputted from the polarization splitter 4 is de-multiplexed by the optical de-multiplexer 5 for each wavelength component, and the delay is added to each of the de-multiplexed wavelength components in the first polarization light by the optical delay 6. And then these wavelength components in the first polarization light are multiplexed by the optical multiplexer 7 prior to input into the polarization combiner 8. The second polarization light outputted from the polarization splitter 4 is inputted into the polarization combiner 8 by way of the bypass optical fiber 9. The first polarization light arriving from the optical multiplexer 7 and the second polarization light arriving from the polarization splitter 4 by way of the bypass optical fiber 9 are combined by and outputted by the polarization combiner 8.

In this way, in the DGD compensating apparatus 1 according to the present embodiment, the inputted light is polarization-split into first polarization light and second polarization light by the polarization splitter 4, and then the split first polarization light is de-multiplexed by the optical de-multiplexer 5 for each wavelength component. The optical delay 6 adds the delay to each of the de-multiplexed wavelength components in the first polarization light. The delay-added wavelength components in the first polarization light are then multiplexed by the optical multiplexer 7, and the first polarization light and the second polarization light are then combined by and outputted by the polarization combiner 8.

Here, the delay added to each wavelength component in the first polarization light by the optical delay 6 is one in accordance with the DGD of each wavelength component in the inputted light obtained by the monitoring of the DGD monitor 2, and is one minimizing the DGD of each wavelength component after the combining of the polarization combiner 8. That is, even when the DGD of each wavelength component in the light, inputted input into the DGD compensating apparatus, time-varies, the DGD is compensated for each wavelength component and thereafter being outputted from the DGD compensating apparatus 1.

The present invention is not restricted to the embodiment described above and, accordingly, a variety of modifications may be made thereto. For example, when a diffraction grating of large polarization dependency in the direction of diffraction (namely, in which significant difference in diffraction occurs in accordance with polarization) is used, the functions of both the polarization splitter 4 and optical de-multiplexer 5 can be realized using a single diffraction grating. The same applies to the optical multiplexer 7 and the polarization combiner 8.

Furthermore, for example, an optical delay 6 that, employing a transmission-type delay element comprising a plurality of pixels configured from a liquid crystal material, is able to vary the delay of the light transmitted through the liquid crystal material in accordance with the incident position (namely , with the wavelength) as a result of the light of each wavelength component de-multiplexed by the optical de-multiplexer 5 being caused to fall incident on different pixels of the transmission-type delay element and the refractive indices of the liquid crystal material of the pixels being changed at each incident position is possible.

In addition, for example, an optical delay 6 that, using an optical fiber or optical waveguide having multiple cores (portion through which light is propagated), is able to add a delay to each wavelength component by changing the optical path length thereof (namely, the delay) by, for example, a physical tensioning, a thermooptical effect, an electrooptical effect or a non-linear optical effect is also possible.

In accordance with the DGD compensating apparatus according to the present invention, the time varying DGD of each wavelength component can be compensated.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A DGD compensating apparatus for compensating Differential Group Delay (DGD) between first and second polarizations orthogonal to each other, which are which is induced during light propagation, said apparatus comprising:
an input port for inputting light having a plurality of wavelength components;
an output port for outputting light in which DGD of each wavelength component in the inputted light is compensated;
a DGD monitor for monitoring DGD of each wavelength component in the inputted light;
a polarization splitter for splitting the inputted light into first polarization light and second polarization light;
an optical de-multiplexer for de-multiplexing the first polarization light for each wavelength component;
an optical delay for adding a delay to each de-multiplexed wavelength component in the first polarization light, according to the associated DGD which is monitored by said DGD monitor;
an optical multiplexer for multiplexing the delay-added wavelength components in the first polarization light; and
a polarization combiner for combining the first polarization light and the second polarization light.

2. A DGD compensating apparatus according to claim 1, wherein said optical delay is provided on an optical path between said optical de-multiplexer and said optical multiplexer.

3. A DGD compensating apparatus according to claim 1, further comprising an optical path for second polarization light which optically connects said polarization splitter to said polarization combiner.

4. A DGD compensating apparatus according to claim 1, wherein said optical delay comprises a variable delay in which a plurality of reflection mirrors, corresponding to the plurality of wavelength components, move independently moved in a vertical direction to a reflection plane of each reflection mirror.

5. A DGD compensating apparatus according to claim 1, wherein said optical delay comprises a transmission-type delay having a plurality of liquid crystal pixels.

6. A DGD compensating apparatus according to claim 1, wherein said optical delay comprises an optical waveguide having multiple cores.
